(19) United States
(12) Patent Application Publication
(10) Pub. No.: US 2025/0096913 A1
(43) Pub. Date: Mar. 20, 2025

(54) WIRELESS COMMUNICATION SYSTEM, COMMUNICATION APPARATUS AND WIRELESS COMMUNICATION METHOD

(71) Applicant: NIPPON TELEGRAPH AND TELEPHONE CORPORATION, Tokyo (JP)

(72) Inventors: Yasuyoshi KOJIMA, Musashino-shi (JP); Daisuke GOTO, Musashino-shi (JP); Kiyohiko ITOKAWA, Musashino-shi (JP); Kazumitsu SAKAMOTO, Musashino-shi (JP); Tomoya KAGEYAMA, Musashino-shi (JP)

(73) Assignee: NIPPON TELEGRAPH AND TELEPHONE CORPORATION, Tokyo (JP)

(21) Appl. No.: 18/727,427

(22) PCT Filed: Jan. 14, 2022
(86) PCT No.: PCT/JP2022/001158

§ 371 Date: Jul. 9, 2024

(51) Int. Cl. H04B 17/318; H04B 7/185

(52) U.S. Cl. CPC H04B 17/318; H04B 7/1851

(57) ABSTRACT

In a wireless communication system including a first communication device, one or more second communication devices disposed around the first communication device, and a relay device that moves, the second communication device includes a second reception unit that attempts to receive a radio wave in a predetermined band and measures reception strength, and a second transmission unit that transmits, to the first communication device, reception result information indicating a peripheral radio wave condition based on the reception strength measured by the second reception unit, and the first communication device includes a first reception unit that attempts to receive a radio wave in the predetermined band and measures reception strength, a determination unit that determines a band to be used for transmission of data to the relay device on a basis of a peripheral radio wave condition based on the reception strength measured by the first reception unit and the peripheral radio wave condition based on the reception result information transmitted from the second transmission unit, and a first transmission unit that transmits the data to the relay device using the band determined by the determination unit.

### TECHNICAL FIELD

The present invention relates to a wireless communication system, a communication apparatus and a wireless communication method.

### BACKGROUND ART

With the development of Internet of Things (IoT) technology, it has been studied to install IoT terminals including various sensors in various places. The IoT terminals may be installed in a place where installation of a base station is difficult, such as on a buoy or on a ship in the sea or in a mountainous area. Therefore, to collect data obtained by the IoT terminals installed in various places, a technology of causing a relay device mounted on a low earth orbit satellite (LEO) to relay transmission of data from the IoT terminals to the base station has been studied.

Many IoT terminals are installed on the ground. Therefore, there is a technology in which a low earth orbit satellite receives a plurality of low power wide area (LPWA) terminal signals transmitted at the same timing with a plurality of antennas and separates the signals into signals for the respective IoT terminals. As a result, the number of IoT terminals accommodated in the low earth orbit satellite can be increased.

Conventionally, an IoT terminal receives a radio wave of a specific frequency for a certain period in communication with a low earth orbit satellite. In a case where the IoT terminal confirms that there are no other terminals interfering with each other, the IoT terminal transmits data to the low earth orbit satellite. However, in a case where a plurality of IoT terminals is located outside a signal coverage, the IoT terminals cannot mutually recognize that radio wave interference occurs, and a hidden terminal problem that causes interference or the like may occur.

In response to such a hidden terminal problem, the technology described in Non Patent Literature 1 controls data transmission timing by transmitting and receiving request to send (RTS)/clear to send (CTS), which are control signals, and prevents occurrence of radio wave interference.

### CITATION LIST

### Non Patent Literature

Non Patent Literature 1: S. Khurana, et al., “Effect of hidden terminals on the performance of IEEE 802.11 MAC protocol”, Proceedings 23rd Annual Conference on Local Computer Networks, IEEE, pp. 12-20, October 1998.

### SUMMARY OF INVENTION

### Technical Problem

However, in a case where communication is performed between the IoT terminal and the low earth orbit satellite, even if the control signal is transmitted from the IoT terminal to the low earth orbit satellite, the control signal does not reach another IoT terminal from the low earth orbit satellite thereafter. Therefore, in this case, the technology using the control signals such as RTS/CTS as described above cannot be applied, and there is a problem that prevention of occurrence of radio wave interference is difficult.

In view of the above circumstances, an object of the present invention is to provide a wireless communication system, a communication apparatus and a wireless communication method capable of further reducing occurrence of radio wave interference.

### Solution to Problem

The first aspect of the present invention is a wireless communication system including a first communication device, one or more second communication devices disposed around the first communication device, and a relay device that moves, the second communication device including: a second reception unit that attempts to receive a radio wave in a predetermined band and measures reception strength; and a second transmission unit that transmits, to the first communication device, reception result information indicating a peripheral radio wave condition based on the reception strength measured by the second reception unit; and the first communication device including: a first reception unit that attempts to receive a radio wave in the predetermined band and measures reception strength; a determination unit that determines a band to be used for transmission of data to the relay device on a basis of a peripheral radio wave condition based on the reception strength measured by the first reception unit and the peripheral radio wave condition based on the reception result information transmitted from the second transmission unit; and a first transmission unit that transmits the data to the relay device using the band determined by the determination unit.

Further, the second aspect of the present invention is a communication device including a first communication unit and one or more second communication units disposed around the first communication unit, and configured to perform communication with a relay device that moves, the second communication unit including: a second reception unit that attempts to receive a radio wave in a predetermined band and measures reception strength; and a second transmission unit that transmits, to the first communication unit, reception result information indicating a peripheral radio wave condition based on the reception strength measured by the second reception unit; and the first communication unit including a first reception unit that attempts to receive a radio wave in the predetermined band and measures reception strength; a determination unit that determines a band to be used for transmission of data to the relay device on a basis of a peripheral radio wave condition based on the reception strength measured by the first reception unit and the peripheral radio wave condition based on the reception result information transmitted from the second transmission unit; and a first transmission unit that transmits the data to the relay device using the band determined by the determination unit.

Further, one aspect of the present invention is a wireless communication method by a first communication device, one or more second communication devices disposed around the first communication device, and a relay device that moves, the wireless communication method including: by the second communication device, a second reception step of attempting to receive a radio wave in a predetermined band and measuring reception strength; by the second communication device, a second transmission step of transmitting, to the first communication device, reception result information indicating a peripheral radio wave condition based on the reception strength measured by the second reception step; by the first communication device, a first reception step of attempting to receive a radio wave in the predetermined band and measuring reception strength; by the first communication device, a determination step of determining a band to be used for transmission of data to the relay device on a basis of a peripheral radio wave condition based on the reception strength measured by the first reception step and the peripheral radio wave condition based on the reception result information transmitted by the second transmission step; and by the first communication device, a first transmission step of transmitting the data to the relay device using the band determined by the determination step.

Further, one aspect of the present invention is a wireless communication method by a communication device that includes a first communication unit and one or more second communication units disposed around the first communication unit, and performs communication with a relay device that moves, the wireless communication method including: by the second communication unit, a second reception step of attempting to receive a radio wave in a predetermined band and measuring reception strength; by the second communication unit, a second transmission step of transmitting, to the first communication unit, reception result information indicating a peripheral radio wave condition based on the reception strength measured by the second reception step; y the first communication unit, a first reception step of attempting to receive a radio wave in the predetermined band and measuring reception strength; by the first communication unit, a determination step of determining a band to be used for transmission of data to the relay device on a basis of a peripheral radio wave condition based on the reception strength measured by the first reception step and the peripheral radio wave condition based on the reception result information transmitted by the second transmission step; and by the first communication unit, a first transmission step of transmitting the data to the relay device using the band determined by the determination step.

### Advantageous Effects of Invention

According to the present invention, it is possible to further reduce occurrence of radio wave interference.

### BRIEF DESCRIPTION OF DRAWINGS

FIG. 1 is a configuration diagram of a wireless communication system according to an embodiment.

FIG. 2 is a flowchart illustrating processing of the wireless communication system according to the embodiment.

FIG. 3 is a flowchart illustrating processing of the wireless communication system according to the embodiment.

FIG. 4 is a diagram illustrating an example of a positional relationship between a terminal station and periphery detection stations according to the embodiment.

FIG. 5 is a block diagram illustrating functional configurations of a terminal station and a periphery detection station according to the embodiment.

FIG. 6 is a flowchart illustrating processing of a conventional wireless communication system.

FIG. 7 is a flowchart illustrating processing of the wireless communication system according to the embodiment.

### DESCRIPTION OF EMBODIMENTS

Hereinafter, embodiments of the present invention will be described in detail with reference to the drawings. First, a basic data transmission configuration among terminal stations, a mobile relay station, and a base station by a wireless communication system of an embodiment will be described.

### [Basic Configuration of Wireless Communication System]

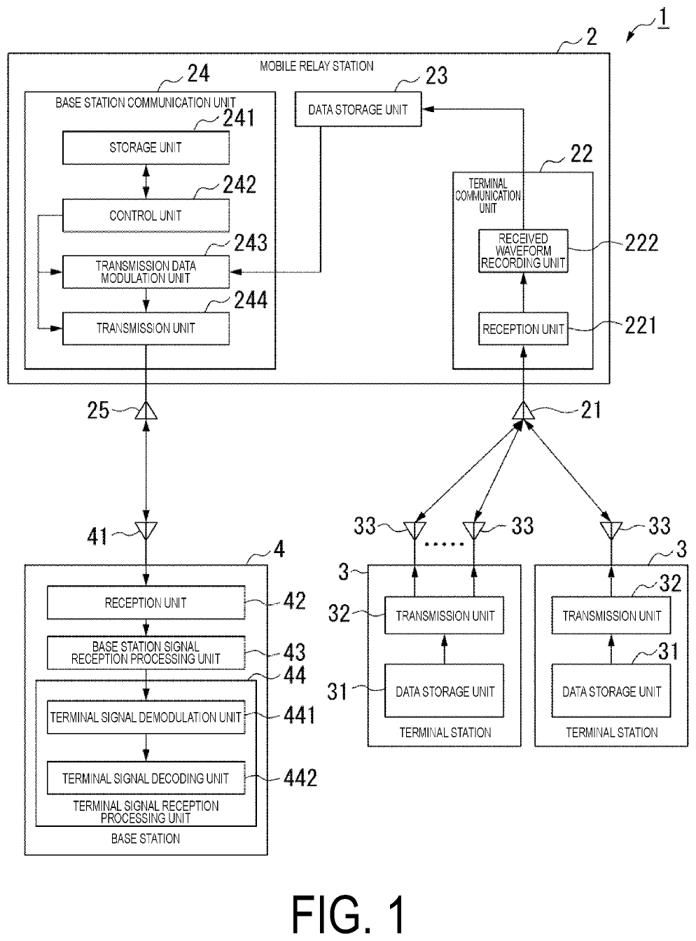

FIG. 1 is a configuration diagram of a wireless communication system 1 according to an embodiment. The wireless communication system 1 includes a mobile relay station 2, terminal stations 3, and a base station 4. Each of the numbers of mobile relay stations 2, terminal stations 3, and base stations 4 included in the wireless communication system 1 is arbitrary, but it is assumed that there is a large number of terminal stations 3.

The mobile relay station 2 is an example of a relay device that is mounted on a mobile object and has a communicable area that moves over time. The mobile relay station 2 is provided in, for example, a low earth orbit (LEO) satellite. The LEO satellite has an altitude of 2000 km or less and orbits in the air over the earth once every about 1.5 hours. The terminal station 3 and the base station 4 are installed on the earth, for example, on the ground or on the sea. The terminal station 3 is, for example, an IoT terminal. The terminal station 3 collects data such as environmental data detected by a sensor and wirelessly transmits the collected data to the mobile relay station 2. FIG. 1 illustrates only two terminal stations 3.

The mobile relay station 2 receives data transmitted from each of the plurality of terminal stations 3 with a wireless signal while moving above the earth. The mobile relay station 2 accumulates the received data and wirelessly and collectively transmits the accumulated data to the base station 4 at timing at which communication with the base station 4 is possible. The base station 4 receives the data collected by the terminal stations 3 from the mobile relay station 2.

As the mobile relay station, use of a relay station mounted on a geosynchronous satellite, a drone, or an unmanned aerial vehicle such as a high altitude platform station (HAPS) is conceivable. However, the relay station mounted on a geosynchronous satellite has a wide coverage area (footprint) on the ground, but has an extremely small link budget with respect to the IoT terminals installed on the ground because its altitude is high. Meanwhile, the relay station mounted on a drone or a HAPS has a high link budget, but has a narrow coverage area. Moreover, a battery is necessary in a drone and a solar panel is necessary in a HAPS.

In the present embodiment, the mobile relay station 2 is mounted on the LEO satellite. Thus, the link budget falls within a limit, and, in addition, the LEO satellite has no air resistance and has low fuel consumption because the LEO satellite orbits outside the atmosphere. In addition, the footprint is also larger than that in a case where a relay station is mounted on a drone or a HAPS.

The mobile relay station 2 mounted on the LEO satellite performs communication while moving at a high speed. Therefore, a time zone in which each terminal station 3 or base station 4 can communicate with the mobile relay station 2 is limited. Specifically, seen from the ground, the mobile relay station 2 passes through the sky in about ten minutes. Further, wireless communication schemes having various specifications are used in the terminal stations 3.

Accordingly, the mobile relay station 2 receives a terminal uplink signal from the terminal station 3 within coverage at a present position during movement and stores waveform data of the received terminal uplink signal. The mobile relay station 2 wirelessly transmits a base station downlink signal in which the waveform data of the terminal uplink signal is set to the base station 4 at the timing when the base station 4 is in the coverage. The base station 4 demodulates the base station downlink signal received from the mobile relay station 2 to obtain the waveform data of the terminal uplink signal. The base station 4 demodulates and decodes the terminal uplink signal represented by the waveform data to obtain terminal transmission data that is data transmitted by the terminal station 3.

Hereinafter, configurations of the mobile relay station 2, the terminal station 3, and the base station 4 will be described.

As illustrated in FIG. 1, the mobile relay station 2 includes an antenna 21, a terminal communication unit 22, a data storage unit 23, a base station communication unit 24, and an antenna 25.

The terminal communication unit 22 includes a reception unit 221 and a received waveform recording unit 222. The reception unit 221 receives the terminal uplink signal through the antenna 21. The received waveform recording unit 222 samples a received waveform of the terminal uplink signal received by the reception unit 221, and generates waveform data indicating a value obtained by the sampling. The received waveform recording unit 222 writes, in the data storage unit 23, received waveform information in which reception time of the terminal uplink signal in the antenna 21 and the generated waveform data are set. The data storage unit 23 stores the received waveform information written by the received waveform recording unit 222.

The base station communication unit 24 transmits the received waveform information to the base station 4 with the base station downlink signal of any wireless communication scheme. The base station communication unit 24 includes a storage unit 241, a control unit 242, a transmission data modulation unit 243, and a transmission unit 244. The storage unit 241 stores transmission start timing calculated in advance on the basis of orbit information of the LEO satellite on which the mobile relay station 2 is mounted and a position of the base station 4. The orbit information of the LEO satellite is information from which a position, a velocity, a movement direction, and the like of the LEO satellite at any time can be obtained. The transmission time may be represented by, for example, an elapsed time from the transmission start timing. The control unit 242 controls the transmission data modulation unit 243 and the transmission unit 244 to transmit the received waveform information to the base station 4 at the transmission start timing stored in the storage unit 241. The transmission data modulation unit 243 reads the received waveform information from the data storage unit 23 as transmission data, and modulates the read transmission data to generate the base station downlink signal. The transmission unit 244 converts the base station downlink signal from an electrical signal into a wireless signal, and transmits the wireless signal from the antenna 25.

As illustrated in FIG. 1, the terminal station 3 includes a data storage unit 31, a transmission unit 32, and one or a plurality of antennas 33.

The data storage unit 31 stores sensor data and the like. The transmission unit 32 reads the sensor data from the data storage unit 31 as the terminal transmission data and wirelessly transmits the terminal uplink signal in which the read terminal transmission data is set from the antenna 33.

The transmission unit 32 transmits the signal by low power wide area (LPWA), for example. Examples of the LPWA include LoRaWAN (registered trademark), Sigfox (registered trademark), long term evolution for machines (LTE-M), and narrow band (NB)-IoT, but any wireless communication scheme can be used. The transmission unit 32 may perform transmission with another terminal station 3 by time division multiplexing, orthogonal frequency division multiplexing (OFDM), or the like.

The transmission unit 32 determines a channel and transmission timing to be used by the local station to transmit the terminal uplink signal by a method determined in advance in the wireless communication scheme to be used. Alternatively, the transmission unit may perform beam formation of signals transmitted from the plurality of antennas 33 on the basis of the method determined in advance in the wireless communication scheme to be used.

As illustrated in FIG. 1, the base station 4 includes an antenna 41, a reception unit 42, a base station signal reception processing unit 43, and a terminal signal reception processing unit 44.

The reception unit 42 converts a terminal downlink signal received through the antenna 41 into an electrical signal. The base station signal reception processing unit 43 demodulates and decodes the received signal converted into the electrical signal by the reception unit 42 to obtain the received waveform information. The base station signal reception processing unit 43 outputs the received waveform information to the terminal signal reception processing unit 44.

The terminal signal reception processing unit 44 performs reception processing for the terminal uplink signal indicated by the received waveform information. At this time, the terminal signal reception processing unit 44 acquires the terminal transmission data by performing the reception processing by the wireless communication scheme used by the terminal station 3 for transmission. The terminal signal reception processing unit 44 includes a terminal signal demodulation unit 441 and a terminal signal decoding unit 442.

The terminal signal demodulation unit 441 demodulates the waveform data and outputs a symbol obtained by the demodulation to the terminal signal decoding unit 442. The terminal signal demodulation unit 441 may perform, for a signal indicated by the waveform data, processing of compensating for a Doppler shift of the terminal uplink signal received by the antenna 21 of the mobile relay station 2, and then perform the demodulation. The Doppler shift applied to the terminal uplink signal received by the antenna 21 is calculated in advance on the basis of the position of the terminal station 3 and the orbit information of the LEO on which the mobile relay station 2 is mounted. The terminal signal decoding unit 442 decodes the symbol demodulated by the terminal signal demodulation unit 441 to obtain the terminal transmission data transmitted from the terminal station 3.

### [Basic Operation of Wireless Communication System]

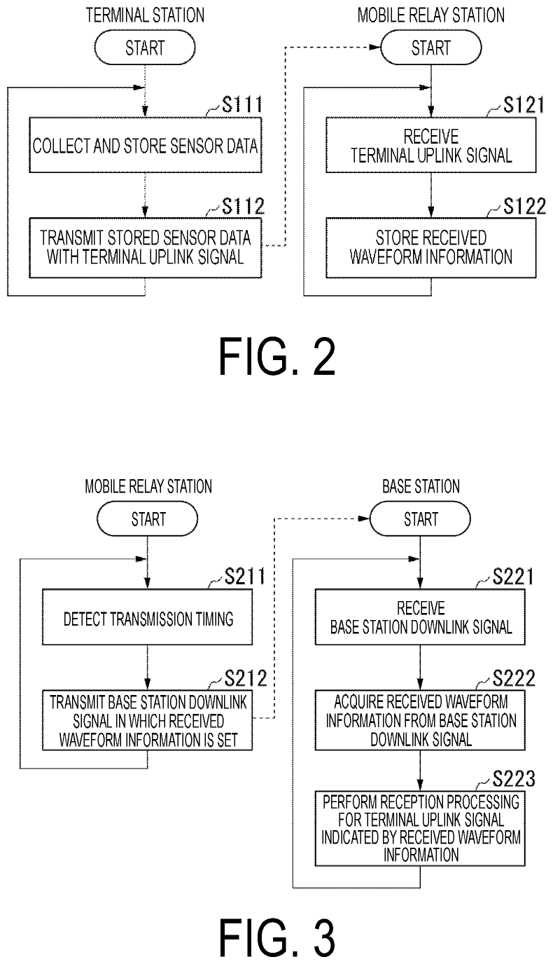

Hereinafter, a basic operation of the wireless communication system 1 will be described below. FIG. 2 is a flowchart illustrating processing of the wireless communication system 1 in a case where an uplink signal is transmitted from the terminal station 3.

The terminal station 3 obtains data detected by an internally or externally provide sensor (not illustrated) as needed, and writes the obtained data in the data storage unit 31 (step S111). The transmission unit 32 reads sensor data from the data storage unit 31 as the terminal transmission data. The transmission unit 32 wirelessly transmits the terminal uplink signal in which the terminal transmission data is set from the antenna 33 at the transmission start timing obtained in advance on the basis of the orbit information of the LEO satellite on which the mobile relay station 2 is mounted (step S112). The terminal station 3 repeats the processing from step S111.

The reception unit 221 of the mobile relay station 2 receives the terminal uplink signal transmitted from the terminal station 3 (step S121). Depending on the wireless communication scheme of the terminal stations 3 serving as transmission sources, there are some cases where the terminal uplink signal is received from only one terminal station 3 by time division at the same frequency, or there are some cases where the terminal uplink signals are simultaneously received from a plurality of terminal stations 3 at the same frequency. The received waveform recording unit 222 writes, in the data storage unit 23, the received waveform information that associates the waveform data representing the waveform of the terminal uplink signal received by the reception unit 221 with reception time (step S122). The mobile relay station 2 repeats the processing from step S121.

FIG. 3 is a flowchart illustrating processing of the wireless communication system 1 in a case where the base station downlink signal is transmitted from the mobile relay station 2. When having detected that current time is the transmission start timing stored in the storage unit 241, the control unit 242 included in the base station communication unit 24 of the mobile relay station 2 instructs the transmission data modulation unit 243 and the transmission unit 244 to transmit the received waveform information (step S211).

The transmission data modulation unit 243 reads the received waveform information accumulated in the data storage unit 23 as the transmission data, modulates the read transmission data, and generates the base station downlink signal. The transmission unit 244 wirelessly transmits the base station downlink signal generated by the transmission data modulation unit 243 through the antenna 25 (step S212). The mobile relay station 2 repeats the processing from step S211.

The antenna 41 of the base station 4 receives the base station downlink signal from the mobile relay station 2 (step S221). The reception unit 42 converts the base station downlink signal received by the antenna 41 into the received signal of the electrical signal and outputs the received signal to the base station signal reception processing unit 43. The base station signal reception processing unit 43 demodulates the received signal, and decodes the demodulated received signal (step S222). The base station signal reception processing unit 43 outputs the received waveform information obtained by the decoding to the terminal signal reception processing unit 44.

The terminal signal reception processing unit 44 performs the reception processing for the terminal uplink signal indicated by the waveform data included in the received waveform information (step S223). Specifically, the terminal signal demodulation unit 441 specifies the wireless communication scheme used by the terminal station 3 to transmit the terminal uplink signal on the basis of information specific to the wireless communication scheme included in the received signal indicated by the waveform data. The terminal signal demodulation unit 441 demodulates the received signal indicated by the waveform data in accordance with the specified wireless communication scheme, and outputs the symbol obtained by the demodulation to the terminal signal decoding unit 442.

The terminal signal decoding unit 442 decodes the symbol input from the terminal signal demodulation unit 441 by the specified wireless communication scheme to obtain the terminal transmission data transmitted from the terminal station 3. Note that the terminal signal decoding unit 442 can also use a decoding scheme with a large calculation load, such as successive interference cancellation (SIC). The base station 4 repeats the processing from step S221.

[Configuration of Wireless Communication System Related to Interference Detection]Hereinafter, a configuration of the wireless communication system 1 related to interference detection will be described. In communication with the mobile relay station 2, the terminal station 3 in the present embodiment attempts to receive a radio wave of a specific frequency for a certain period in advance before transmitting desired data to the mobile relay station 2. The terminal station 3 transmits data to the mobile relay station 2 in a case of confirming that there are no other terminal stations 3 interfering with each other on the basis of a reception result.

Further, in the wireless communication system 1 according to the present embodiment, one or more periphery detection stations 8 are installed around each terminal station 3 (a communication apparatus). Similarly to the terminal station 3, the periphery detection station 8 also attempts to receive a radio wave of a specific frequency for a certain period in advance. The periphery detection station 8 transmits the reception result to the terminal station 3. The terminal station 3 checks whether there are other terminal stations 3 that interfere with each other in consideration of not only the reception result in the local device but also the reception results in the one or more periphery detection stations 8. As a result, the terminal station 3 can confirm whether there are other terminal stations 3 that interfere with each other on the basis of the reception results in a wider range.

With such a configuration, in the wireless communication system 1 according to the present embodiment, the terminal station 3 can detect the other terminal stations 3 interfering with each other with higher accuracy. As a result, the wireless communication system 1 according to the present embodiment can further reduce the occurrence of radio wave interference in the communication between the mobile relay station 2 and the terminal station 3.

Note that, in the present embodiment, the periphery detection station 8 is a wireless station for exclusive use for reception dedicated to attempting to receive the radio wave of a specific frequency and transmitting the reception result to the terminal station 3, but the present embodiment is not limited thereto. For example, each of the periphery detection stations 8 may be configured to appropriately function as the terminal station 3 that transmits and receives data to and from the mobile relay station 2.

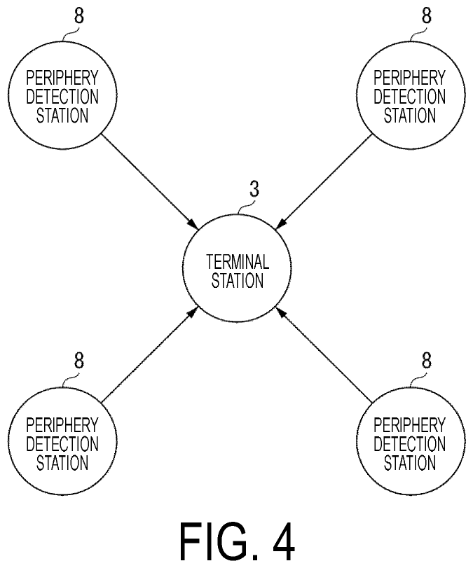

FIG. 4 is a diagram illustrating an example of a positional relationship among the terminal station 3 and the periphery detection stations 8. As illustrated in FIG. 4, the plurality of periphery detection stations 8 is installed at predetermined intervals at positions on a substantially concentric circle centered on the position of the terminal station 3, for example. As a result, the terminal station 3 can check whether there are other terminal stations 3 that interfere with each other on the basis of a reception state in a wider range.

Note that the positional relationship among the terminal station 3 and the periphery detection stations 8 is not limited to that illustrated in FIG. 1. For example, there may be a shield that shields radio waves such as undulations of terrain, an obstacle that reflects radio waves such as a building, or the like around the terminal station 3. In such a case, the periphery detection station 8 is desirably arranged at an appropriate position according to intensity of transmission and reception of the radio waves, the modulation method, and the type of interference source (pulse wave, white noise, or the like).

Note that communication between the periphery detection station 8 and the terminal station 3 may be either wireless communication or wired communication.

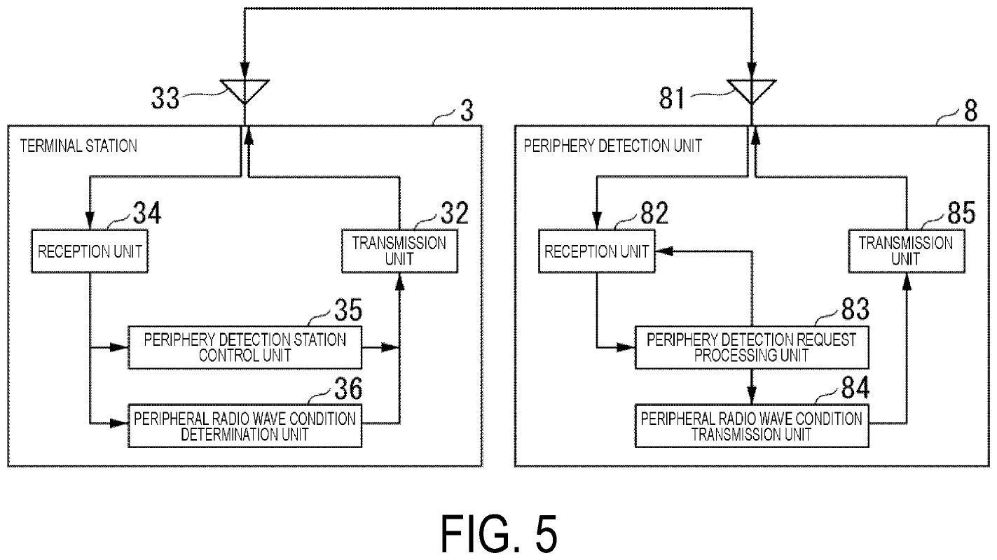

Hereinafter, configurations of the terminal station 3 and the periphery detection station 8 related to interference detection will be described. FIG. 5 is a block diagram illustrating functional configurations of the terminal station 3 and the periphery detection station 8 related to interference detection. Note that FIG. 5 illustrates only a functional configuration related to interference detection, and description of other functional configurations is omitted. That is, the terminal station 3 further has the functional configuration illustrated in the block diagram of FIG. 5 in addition to the functional configuration illustrated in the block diagram of FIG. 1. Note that, in FIG. 5, functional units common to those in FIG. 1 are denoted by the same reference numerals, and description thereof may be omitted.

As illustrated in FIG. 5, the terminal station 3 includes the transmission unit 32, the antenna 33, a reception unit 34, a periphery detection station control unit 35, and a peripheral radio wave condition determination unit 36.

The transmission unit 32 acquires a periphery detection request output from the periphery detection station control unit 35. The periphery detection request is a request signal for causing the periphery detection station 8 to receive, for a certain period of time, a band desired to be used by the terminal station 3 for data transmission to the mobile relay station 2. The transmission unit 32 transmits the acquired periphery detection request to the periphery detection station 8 via the antenna 33.

Further, in a case where it is not determined by the peripheral radio wave condition determination unit 36 that a reception level has exceeded a predetermined threshold in the terminal station 3 and the periphery detection station 8 over a certain period, the transmission unit 32 transmits desired data to the mobile relay station 2 using the above-described band desired to be used.

The reception unit 34 attempts to receive the band desired to be used for transmission of data to the mobile relay station 2 for a certain period. The reception unit 34 outputs information indicating a reception result to the peripheral radio wave condition determination unit 36.

Furthermore, the reception unit 34 receives each piece of reception result information transmitted from one or more periphery detection stations. The reception result information is information indicating a result of reception using the band desired to be used, which has been attempted by the periphery detection station 8 in response to the above-described periphery detection request. The reception unit 34 outputs the received reception result information to the peripheral radio wave condition determination unit 36.

The periphery detection station control unit 35 transmits the periphery detection request to each of the one or more periphery detection stations 8 via the transmission unit 32 and the antenna 33, for example, at timing when the terminal station 3 and the mobile relay station 2 become able to communicate with each other.

The peripheral radio wave condition determination unit 36 acquires, from the reception unit 34, information indicating the reception result of reception by the reception unit 34 in the band desired to be used for transmission of data to the mobile relay station 2 and the reception result information acquired from each of the one or more periphery detection stations. The peripheral radio wave condition determination unit 36 determines whether the reception level has not exceeded a predetermined threshold in the terminal station 3 or the periphery detection station 8 over a certain period on the basis of the acquired information. In the case where it is determined that the reception level has not exceeded the predetermined threshold in the terminal station 3 and the periphery detection station 8 over the certain period, the peripheral radio wave condition determination unit 36 causes the transmission unit 32 to transmit desired data to the mobile relay station 2 using the above-described band desired to be used.

Furthermore, as illustrated in FIG. 5, the periphery detection station 8 includes an antenna 81, a reception unit 82, a periphery detection request processing unit 83, a peripheral radio wave condition transmission unit 84, and a transmission unit 85.

The reception unit 82 receives the periphery detection request transmitted from the terminal station 3 through the antenna 81. The reception unit 82 outputs the received periphery detection request to the periphery detection request processing unit 83.

The periphery detection request processing unit 83 acquires the periphery detection request output from the reception unit 82. The periphery detection request processing unit 83 attempts to receive the band desired to be used for transmission of data to the mobile relay station 2 for a certain period through the reception unit 82 and the antenna 81 on the basis of the acquired periphery detection request.

The periphery detection request processing unit 83 determines whether the reception level has not exceeded a predetermined threshold over a certain period. The periphery detection request processing unit 83 outputs the reception result information indicating the result of the determination to the peripheral radio wave condition transmission unit 84.

The peripheral radio wave condition transmission unit 84 acquires the reception result information output from the periphery detection request processing unit 83. The peripheral radio wave condition transmission unit 84 transmits the acquired reception result information to the terminal station 3 via the transmission unit 85 and the antenna 81.

### [Operations of Terminal Station and Periphery Detection Station Related to Interference Detection]

Hereinafter, operations of the terminal station 3 and the periphery detection station 8 related to interference detection will be described. First, an example of an operation of a conventional terminal station related to interference detection will be described for easy understanding of the description.

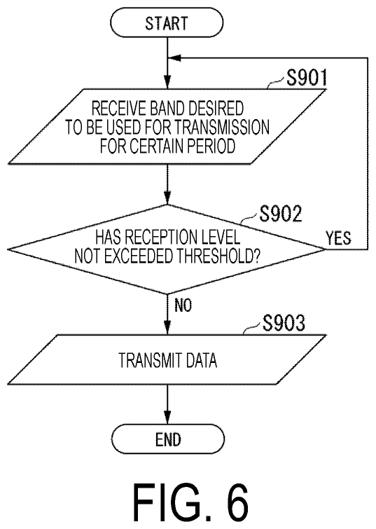

FIG. 6 is a flowchart illustrating an operation of a conventional terminal station related to interference detection. The operation of the conventional terminal station illustrated in the flowchart of FIG. 6 is started at timing when the conventional terminal station and a mobile relay station becomes able to communicate with each other.

First, the conventional terminal station attempts to receive a band desired to be used for transmission of data to the mobile relay station for a certain period (step $901).

Next, the conventional terminal station measures a reception level and determines whether the measured reception level has exceeded a predetermined threshold (step S902).

Next, in a case where it is determined that the reception level has not exceeded the predetermined threshold over the certain period (step S902: NO), the conventional terminal station transmits desired data to the mobile relay station using the above-described band desired to be used (step S903). As described above, the operation of the conventional terminal station related to interference detection illustrated in the flowchart of FIG. 6 ends.

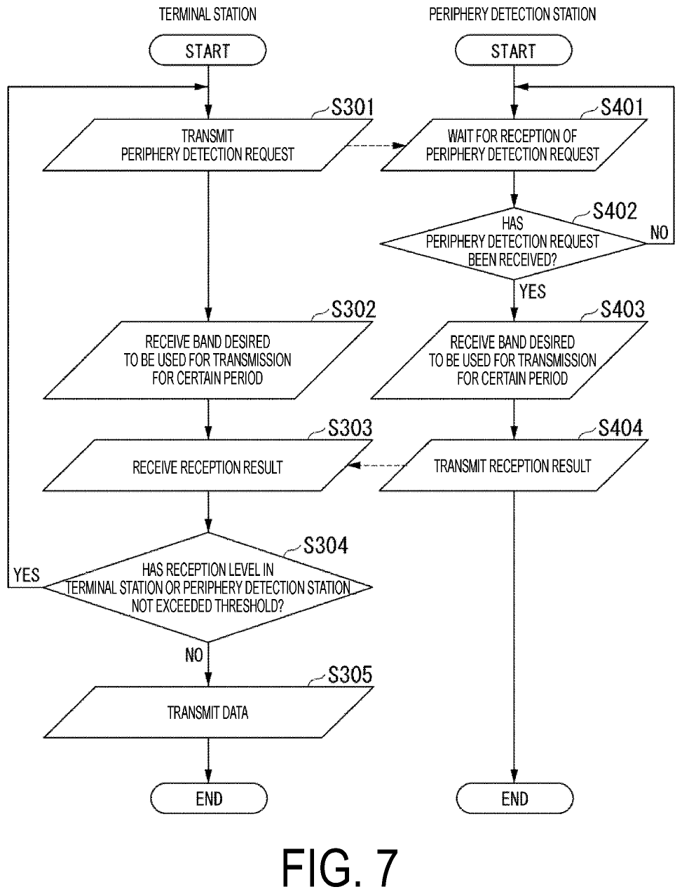

Hereinafter, an example of operations related to interference detection of the terminal station 3 and the periphery detection station 8 of the wireless communication system 1 according to the present embodiment will be described. FIG. 7 is a flowchart illustrating operations of the terminal station 3 and the periphery detection station 8 related to interference detection. The operations of the terminal station 3 and the periphery detection station 8 illustrated in the flowchart of FIG. 7 are started at timing when the terminal station 3 and the mobile relay station 2 become able to communicate with each other, for example.

First, the periphery detection station control unit 35 of the terminal station 3 transmits the periphery detection request to each of the one or more periphery detection stations 8 via the transmission unit 32 and the antenna 33 (step S301).

Next, the reception unit 34 of the terminal station 3 attempts to receive the band desired to be used for transmission of data to the mobile relay station 2 for a certain period through the antenna 33 (step S302). The reception unit 34 outputs the information indicating the reception result to the peripheral radio wave condition determination unit 36. Furthermore, the reception unit 34 waits for reception of the reception result information transmitted from the periphery detection station 8.

Next, the reception unit 82 of the periphery detection station 8 waits for reception of the periphery detection request transmitted from the terminal station 3 in step S301 described above (step S401).

In the case of receiving the periphery detection request transmitted from the terminal station 3 via the antenna 81 (step S402: YES), the reception unit 82 of the periphery detection station 8 outputs the received periphery detection request to the periphery detection request processing unit 83. The periphery detection request processing unit 83 attempts to receive the band desired to be used for transmission of data to the mobile relay station 2 for a certain period through the reception unit 82 and the antenna 81 (step S403).

Next, the periphery detection request processing unit 83 of the periphery detection station 8 determines whether the reception level has not exceeded a predetermined threshold over a certain period. The periphery detection request processing unit 83 outputs the reception result information indicating the result of the determination to the peripheral radio wave condition transmission unit 84. The peripheral radio wave condition transmission unit 84 transmits the acquired reception result information to the terminal station 3 via the transmission unit 85 and the antenna 81 (step S404). As described above, the operation of the periphery detection station 8 related to interference detection illustrated in the flowchart of FIG. 7 ends.

Next, the reception unit 34 of the terminal station 3 receives each piece of the reception result information transmitted from the one or more periphery detection stations (step S303). The reception unit 34 outputs the acquired reception result information to the peripheral radio wave condition determination unit 36.

Next, the peripheral radio wave condition determination unit 36 of the terminal station 3 determines whether the reception level has not exceeded the predetermined threshold in the terminal station 3 or the periphery detection station 8 over a certain period on the basis of the reception result of the reception by the reception unit 34 in the band desired to be used for transmission of data to the mobile relay station 2 and the reception result indicated by the reception result information acquired from each of the one or more periphery detection stations (step S304). Next, in the case where it is not determined that the reception level has exceeded the predetermined threshold in the terminal station 3 and the periphery detection station 8 over the certain period (step S304, NO), the transmission unit 32 of the terminal station 3 transmits the desired data to the mobile relay station 2 using the above-described band desired to be used (step S305). As described above, the operation of the terminal station 3 related to interference detection illustrated in the flowchart of FIG. 7 ends.

As described above, the wireless communication system 1 according to the present embodiment includes the one or more periphery detection stations 8 installed around the terminal station 3. To determine the band to be used for transmission of data to the mobile relay station 2, the terminal station 3 checks in advance whether the band desired to be used interferes with other terminal stations 3. At this time, the terminal station 3 performs the check by attempting to receive the band desired to be used for a certain period.

Furthermore, the terminal station 3 causes not only the own device to perform the check but also the one or more periphery detection stations 8 installed around the local device to perform reception and check in the band desired to be used. The terminal station 3 collects the reception result information from the one or more periphery detection stations 8. As a result, the terminal station 3 can check whether the band desired to be used interferes with other terminal stations 3 on the basis of a reception status in a wider range. Therefore, the wireless communication system 1 according to the present embodiment can further reduce the occurrence of radio wave interference in the communication between the mobile relay station 2 and the terminal station 3.

Further, in the wireless communication system 1 according to the present embodiment, it is not necessary to use a control signal for controlling transmission timing such as RTS and CTS, for example. Thereby, it is possible to suppress the occurrence of radio wave interference even in the wireless communication system having the time zone in which the mobile relay station 2 and the terminal station 3 communicate with each other is limited.

Further, according to the above-described embodiment, the mobile relay station stores and accumulates information of the received signal waveform without demodulating the radio terminal uplink signal received from the terminal station, and performs wireless transmission at timing when communication with the base station is possible. The base station performs the reception processing such as demodulation and decoding of the terminal uplink signal indicated by the received signal waveform in the mobile relay station. Thus, a non-regenerative relay scheme that does not depend on the communication scheme can be applied to the wireless communication system using a low earth orbit satellite.

In addition, since non-regenerative relay is performed, the mobile relay station does not need to implement a wireless communication scheme used for the terminal station. For example, in a case where a terminal station that performs communication by using a new wireless communication scheme is added, a change to the mobile relay station is not necessary, and the only change to be made is to add the wireless communication scheme to the base station installed on the ground. It is therefore possible to simultaneously accommodate various IoT systems, and it is also possible to easily deal with an update of the IoT systems according to the above-described embodiment.

In addition, according to the above-described embodiment, since processing for a large Doppler shift applied to each terminal station can be performed by the base station instead of the mobile relay station, it is not necessary to implement, in the mobile relay station, a complicated nonlinear operation for compensating for the Doppler shift.

Note that, in the above embodiment, the case where the mobile object on which the mobile relay station is mounted is an LEO satellite has been described. However, the mobile object may be another flying object capable of flying, such as a geostationary satellite, a drone, or a HAPS.

Note that the mobile relay station 2 may transmit the base station downlink signals through the plurality of antennas 25. For example, multiple input multiple output (MIMO) may be used to transmit the base station downlink signals. In this case, the mobile relay station 2 can collectively transmit the data, which have received from the plurality of terminal stations 3 and accumulated with good quality, in a short time at timing when communication with the base station 4 is possible.

Note that the mobile relay station 2 may receive the terminal uplink signals using a plurality of antennas 21. For example, the mobile relay station 2 may receive the terminal uplink signal received from the terminal station 3 by diversity reception, MIMO reception, or the like. In this case, the mobile relay station 2 can improve the link budget between the mobile relay station 2 and the terminal station 3.

According to the above-described embodiment, the wireless communication system includes a first communication device, one or more second communication devices arranged around the first communication device, and a relay device that moves. For example, the wireless communication system is the wireless communication system 1 in the embodiment, the first communication device is the terminal station 3 in the embodiment, the second communication device is the periphery detection station 8 in the embodiment, and the relay device is the mobile relay station 2 in the embodiment.

The second communication device includes a second reception unit and a second transmission unit. The second reception unit attempts to receive a radio wave in a predetermined band and measures reception strength. The second transmission unit transmits, to the first communication device, reception result information indicating the peripheral radio wave condition based on the reception strength measured by the second reception unit. For example, the predetermined band is a band desired to be used by the terminal station 3 in the embodiment to transmit data to the mobile relay station 2, the second reception unit is the reception unit 82 of the periphery detection station 8 in the embodiment, and the second transmission unit is the transmission unit 85 of the periphery detection station 8 in the embodiment.

The first communication device includes a first reception unit, a determination unit, and a first transmission unit. The first reception unit attempts to receive a radio wave in a predetermined band and measures reception strength. The determination unit determines a band to be used for transmission of data to the relay device on the basis of the peripheral radio wave condition based on the reception strength measured by the first reception unit and the peripheral radio wave condition based on the reception result information transmitted from the second transmission unit. The first transmission unit transmits the data to the relay device using the band determined by the determination unit. For example, the first reception unit is the reception unit 34 in the embodiment, the determination unit is the peripheral radio wave condition determination unit 36 in the embodiment, and the first transmission unit is the transmission unit 32 in the embodiment.

Note that the first transmission unit transmits request information for causing the second reception unit to receive a radio wave in a predetermined band. In this case, the second reception unit receives the radio wave in the predetermined band when receiving request information. For example, the request information is the periphery detection request in the embodiment.

Note that the first transmission unit transmits the request information at timing when the first reception unit and the second reception unit can communicate with the relay device. For example, the timing when communication is possible is timing when the mobile relay station 2 according to the embodiment passes over the terminal station 3 and the periphery detection station 8.

Note that the relay device may be included in a low earth orbit satellite, and the first communication device and the second communication device may be installed on the earth.

Note that the wireless communication system may further include a third communication device. For example, the third communication device is the base station 4 in the embodiment. In this case, the relay device includes a relay device transmission unit. For example, the relay device transmission unit is the transmission unit 244 in the embodiment. The relay device transmission unit transmits data acquired from the first communication device to the third communication device at timing when communication with the third communication device is possible. For example, the timing when communication is possible is timing when the mobile relay station 2 according to the embodiment passes over the base station 4.

A part or the whole of the configuration of the wireless communication system 1 in the above-described embodiment may be implemented by a computer. In that case, a program for implementing this function may be recorded in a computer-readable recording medium, and the program recorded in the recording medium may be read and executed by a computer system to implement this function. Note that the “computer system” mentioned herein includes an OS and hardware such as peripheral devices. Also, the “computer-readable recording medium” is a portable medium such as a flexible disk, a magneto-optical disc, a ROM, or a CD-ROM, or a storage device such as a hard disk embedded in the computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. Also, the foregoing program may be for implementing some of the functions described above, may be implemented in a combination of the functions described above and a program already recorded in a computer system, or may be implemented with a programmable logic device such as a field programmable gate array (FPGA).

Although the embodiment of the present invention has been described in detail with reference to the drawings, the specific configuration is not limited to the embodiment, and includes design and the like within a range not departing from the gist of the present invention.

### REFERENCE SIGNS LIST

1 Wireless communication system

2 Mobile relay station

3 Terminal station

4 Base station

8 Periphery detection station

21 Antenna

22 Terminal communication unit

23 Data storage unit

24 Base station communication unit

25 Antenna

31 Data storage unit

32 Transmission unit

33 Antenna

34 Reception unit

35 Periphery detection station control unit

36 Peripheral radio wave condition determination unit

41 Antenna

42 Reception unit

43 Base station signal reception processing unit

44 Terminal signal reception processing unit

81 Antenna

82 Reception unit

83 Periphery detection request processing unit

84 Peripheral radio wave condition transmission unit

85 Transmission unit

221 Reception unit

222 Received waveform recording unit

241 Storage unit

242 Control unit

243 Transmission data modulation unit

244 Transmission unit

44 Terminal signal demodulation unit

442 Terminal signal decoding unit

1. A wireless communication system including a first communication device, one or more second communication devices disposed around the first communication device, and a relay device that moves, the second communication device comprising:
a second receptor configured to attempt to receive a radio wave in a predetermined band and measures reception strength; and
a second transmitter configured to transmit, to the first communication device, reception result information indicating a peripheral radio wave condition based on the reception strength measured by the second receptor; and
the first communication device comprising:
a first receptor configured to attempt to receive a radio wave in the predetermined band and measures reception strength;
a determiner configured to determine a band to be used for transmission of data to the relay device on a basis of a peripheral radio wave condition based on the reception strength measured by the first receptor and the peripheral radio wave condition based on the reception result information transmitted from the second transmitter; and
a first transmitter configured to transmit the data to the relay device using the band determined by the determiner.

2. The wireless communication system according to claim 1, wherein
the first transmitter is configured to transmit request information for causing the second reception unit receptor to receive the radio wave in the predetermined band, and
the second receptor is configured to receive the radio wave in the predetermined band in a case of receiving the request information.

3. The wireless communication system according to claim 2, wherein
the first transmitter is configured to transmit the request information at timing when the first receptor and the second receptor are able to communicate with the relay device.

4. The wireless communication system according to claim 1, wherein
the relay device is provided in a low earth orbit satellite, and
the first communication device and the second communication device are installed on earth.

5. The wireless communication system according to claim 1, further comprising:
a third communication device, wherein
the relay device includes
a relay device transmitter configured to transmit the data acquired from the first communication device to the third communication device at timing when communication with the third communication device is possible.

6. A communication device including a first communicator and one or more second communicator disposed around the first communicator, and configured to perform communication with a relay device that moves,
the second communicator comprising:
a second receptor configured to attempt to receive a radio wave in a predetermined band and measures reception strength; and
a second transmitter configured to transmit, to the first communicator, reception result information indicating a peripheral radio wave condition based on the reception strength measured by the second receptor; and
the first communicator comprising:
a first receptor configured to attempt to receive a radio wave in the predetermined band and measures reception strength;
a determiner configured to determine a band to be used for transmission of data to the relay device on a basis of a peripheral radio wave condition based on the reception strength measured by the first receptor and the peripheral radio wave condition based on the reception result information transmitted from the second transmitter; and
a first transmitter configured to transmit the data to the relay device using the band determined by the determiner.

7. A wireless communication method by a first communication device, one or more second communication devices disposed around the first communication device, and a relay device that moves, the wireless communication method comprising:
by the second communication device, attempting to receive a radio wave in a predetermined band and measuring reception strength;
by the second communication device, transmitting, to the first communication device, reception result information indicating a peripheral radio wave condition based on the reception strength measured;
by the first communication device, attempting to receive a radio wave in the predetermined band and measuring reception strength;
by the first communication device, determining a band to be used for transmission of data to the relay device on a basis of a peripheral radio wave condition based on the reception strength measured and the peripheral radio wave condition based on the reception result information transmitted; and
by the first communication device, transmitting the data to the relay device using the band determined.

8. A wireless communication method by a communication device that includes a first communicator and one or more second communicator disposed around the first communicator, and performs communication with a relay device that moves, the wireless communication method comprising:
by the second communicator, attempting to receive a radio wave in a predetermined band and measuring reception strength;
by the second communicator, transmitting, to the first communicator, reception result information indicating a peripheral radio wave condition based on the reception strength measured;
by the first communicator, attempting to receive a radio wave in the predetermined band and measuring reception strength;
by the first communicator, determining a band to be used for transmission of data to the relay device on a basis of a peripheral radio wave condition based on the reception strength measured and the peripheral radio wave condition based on the reception result information transmitted; and
by the first communicator, transmitting the data to the relay device using the band determined.
